(19) United States
(12) Patent Application Publication
(10) Pub. No.: US 2009/0222443 A1
(43) Pub. Date: Sep. 3, 2009

(54) Method and system for matching organizations based on profile and criteria

(76) Inventor: Brent Andrew Bosen, Fox Lake, IL (US)

Correspondence Address: Brent A. Bosen, 1098 Grass Lake Rd., Fox Lake, IL, 60020, US

(21) Appl. No.: 12/395,607

(22) Filed: Feb. 27, 2009

Related U.S. Application Data
(60) Provisional application No. 61/032,625, filed on Feb. 29, 2008.
(60) Provisional application No. 61/033,137, filed on Mar. 3, 2008.

(51) Int. Cl. G06F 17/30

(52) U.S. Cl. 707/5; 707/E17.014

(57) ABSTRACT

A means of matching diverse organizations with relevant partners such as retailers with suppliers, manufacturers with distributors, and universities and government agencies with service providers. Provides a bilateral match where the needs of 2 matched organizations are met based on specific organizational profile and desired partner criteria.

### CROSS REFERENCE TO RELATED APPLICATIONS

This application claims the benefit of PPA Application No. 61/032,625 filed on 2008 Feb. 29 by the present inventor and PPA Application No. 61/033,137 filed on 2008 Mar. 3 also by the present inventor.

### BACKGROUND OF THE INVENTION

Organizations seeking goods and services and the distribution of their goods and services experience significant boundaries including distance, language, and the means for identifying appropriate partners. Much effort is exerted from trade organizations and government entities to develop the efficient distribution of a country's goods and services to the world. Conversely much effort is exerted by individual organizations to ensure efficient supply chains by locating goods and services from the best possible partners.

Systems employing data storing and web server technology in unilateral search applications have become widely used where organizational information is stored and retrieved based on the criteria of the searcher. This invention provides a means of bilateral matching of 2 organizations where the result is based on the satisfaction of matched criteria and profile information input by both organizations.

This invention relates to organizational partnering including but not limited to efficient matching of retailers with suppliers, manufacturers with distributors, educational institutions and government agencies with service providers, and corporations with merger and acquisition candidates.

### BRIEF SUMMARY OF THE INVENTION

This invention is a central system that matches diverse organizations based upon profile and criteria. Organizations seeking to ally with other organizations provide profile information describing their organization and criteria for the targeted partner. The profile and partner criteria collected for each organization is stored centrally. Query of the stored profile and criteria identifies matches among organizations. Organizations with matching needs based on profile and criteria are provided information about matched partners and/or the means for contacting their matched partners.

### BRIEF DESCRIPTION OF DRAWINGS OF THE INVENTION

FIG. 001 shows example of a match between 2 organizations utilizing web access points facilitated by web server and data warehouse

FIG. 002 shows an example of a data query producing a match between the organizations in FIG. 001

FIG. 003 shows an example of an English version of an internet page to collect data

FIG. 004 shows an example of a Japanese version of an internet page to collect data. Items 004a-004f are English translations to facilitate illustration

FIG. 005 shows an example of a dashboard with resulting match information

### DETAILED DESCRIPTION OF THE INVENTION

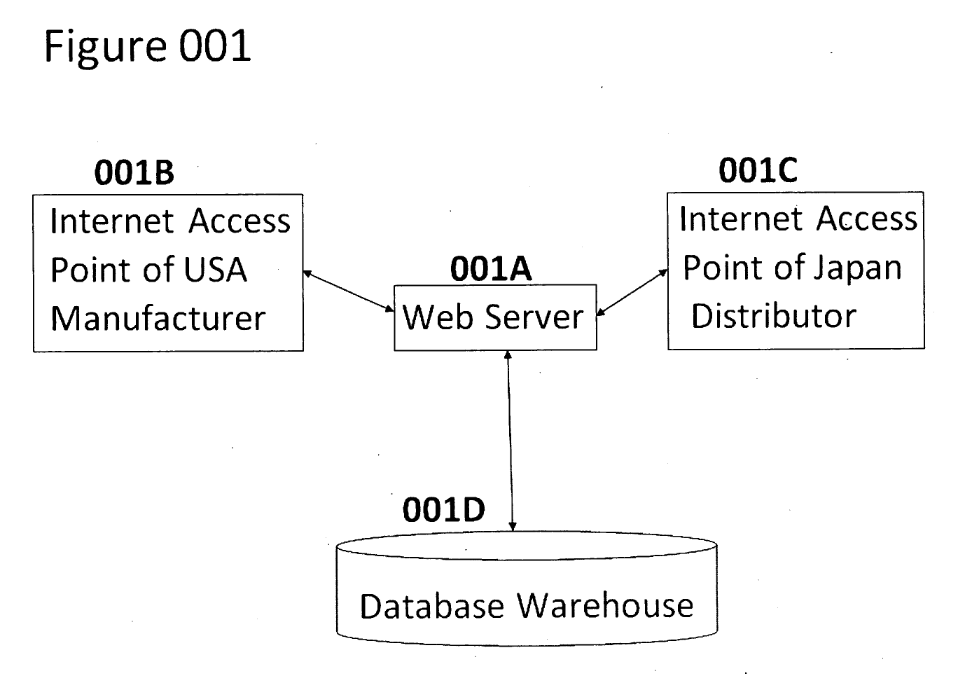

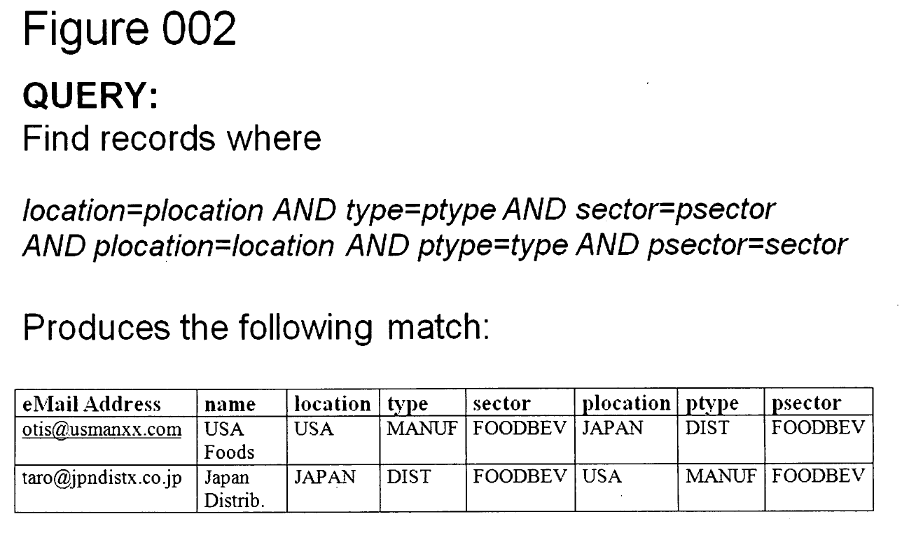

Implementing this system involves providing access through means such as internet pages hosted on web server (FIG. 001 Item 001A), storing the data in a data warehouse, querying the data warehouse for matches, and providing the matched results to the matched organizations. A match is produced when the Profile for Organization A match the Partner Criteria for Organization B AND the Partner Criteria for Organization A match the Profile for Organization B as depicted in FIG. 002.

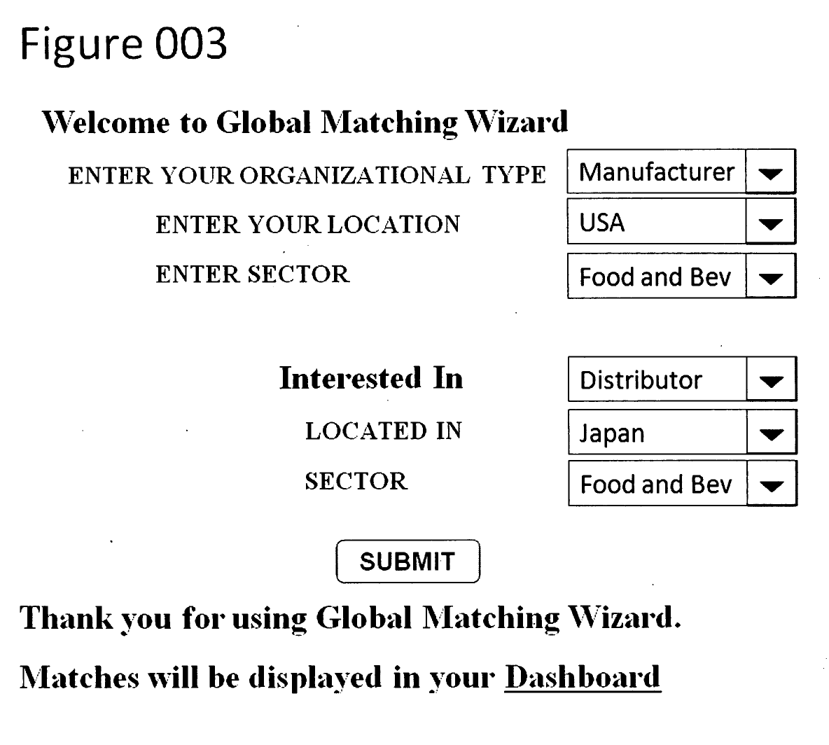

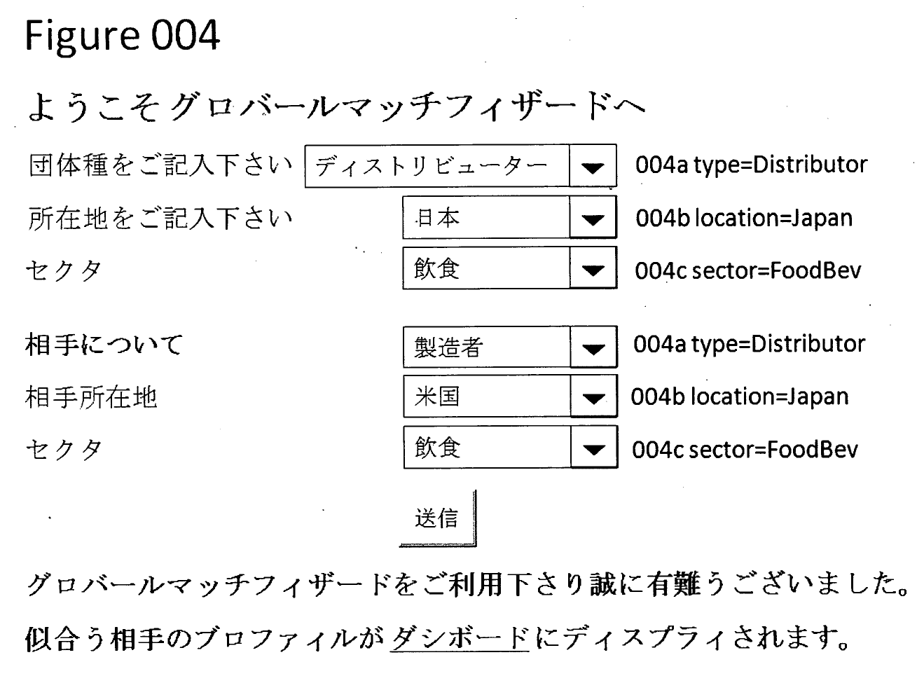

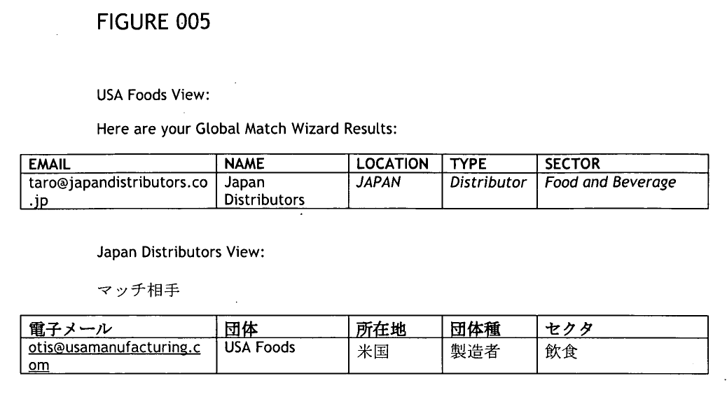

Profile and Partner Criteria are entered in input pages depicted in FIGS. 003 and 004. The input pages include drop downs and/or character boxes that allow representatives from organizations to input profile and criteria information. Data is systematically queried for matches. Profile information for identified matches is made available to matched organizations via a dashboard webpage an example of which is illustrated in FIG. 005.

The use of 2 organizations and 3 criteria is to facilitate explanation and should not be construed as limiting features of the invention. Indeed the value of the invention for each participating organization is increased with the quantity of participating organizations and the focus of the matches. With the increase of participating organizations, more limiting criteria may be employed to ensure more focused matches. Possible additional criteria include language, primary activity, areas of interest, verification, size of organization in employees, size of organization in terms of revenue, etc. The format and content of the examples are for illustrative purposes. The dashboard may include such useful features as links to contact the member, sending and receiving of contact information, invitations to online chatting sessions and video conferencing or other useful features to facilitate cooperation between the matching organizations.

Free form text boxes for product specific matches and profile based information may be included to provide for matching based on specific key words and matching based on the percentage of matched key word in a free form profile text description.

While the example here is international, the invention provides for the matching of organizations in county, sector, region, and industry specific applications.

1. A method and system for matching diverse organizations including the steps of:
a—Storing profile and partner criteria data for a set of organizations
b—Querying the data to identify matches among organizations
c—Providing pertinent information to matched organizations
